(19) United States
(12) Patent Application Publication
(10) Pub. No.: US 2014/0092232 A1
(43) Pub. Date: Apr. 3, 2014

(54) IMAGE OBTAINING DEVICE AND DETECTING APPARATUS HAVING THE SAME

(71) Applicant: Hsin-hua Chen, Shenzhen (CN)

(72) Inventor: Hsin-hua Chen, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/810,897

(22) PCT Filed: Oct. 24, 2012
(86) PCT No.: PCT/CN2012/083396

§ 371 Date: Jan. 18, 2013

(30) Foreign Application Priority Data
Sep. 29, 2012 (CN) 201220514831.7

(51) Int. Cl. H04N 5/225

(52) U.S. Cl. CPC H04N 5/2252
USPC 348/81

(57) ABSTRACT

An image obtaining device is provided, including a waterproof casing, a CCD image transducer mounted in the waterproof casing, a motor having a driving shaft and being mounted in the waterproof casing, and a transparent plate covered on one side of the waterproof casing, connected to the driving shaft of the motor, and driven to rotate by the motor. A detecting apparatus having the above image obtaining device is further provided. The detecting apparatus also includes a LED lighting device configured corresponding to the image obtaining device and an image processing device connected to the CCD image transducer of the image obtaining device. The transparent plate is driven to rotate by the motor to generate centrifugal force to throw away the droplets and water stains on the image obtaining device, thereby improving the detecting precision of the apparatus and the yield rate of the to-be-detected object.

### BACKGROUND

1. Technical Field

The present disclosure relates to optical detecting technologies and, particularly, to an image obtaining device and a detecting apparatus having the same.

2. Description of Related Art

Optical image detection is commonly used in industries such as national defense, medical treatment, semiconductor, and liquid crystal panel manufacture. In the optical image detection, an optical instrument is used for obtaining the superficial state of the to-be-detected object and computer image processing technology is applied to find out defects of the to-be-detected object, for example, whether there is any image abnormality of the object or any foreign matter in the object.

The manufacturing process of a liquid crystal panel includes a number of wet processes such as wet etching process. After the wet processes, droplets or water stains may be remained on the liquid crystal panel. In this state, when using an optical image detecting system to detect the liquid crystal panel, the droplets or water stains may stick to the lens of the optical instrument of the optical image detecting system, for example, the droplets or water stains may stick to the lens of the CCD image transducer, causing the detecting system to capture and judge the obtained image by mistake and further fail to detect the liquid crystal panel precisely. For example, after the droplets stick to a linear scanning type of CCD image transducer, black strips may appear on the image obtained by the linear scanning type of CCD image transducer; after the droplets stick to a zone scanning type of CCD image transducer and are further nebulized, white strips may appear on the image obtained by the zone scanning type of CCD image transducer after the image is processed to be a grayscale image.

The problem of the present optical image detecting technology lies in: the optical image detecting system is easily affected by moisture, droplets, and water stains when being applied in the wet processes of the liquid crystal panel; when moisture or droplets are remained on the lens of the optical instrument, the detecting system may capture the image by mistake and further misjudge the image. High-pressure air supplied from a nozzle is generally used for solving the problem, in which high-pressure air is blown onto the lens to disperse the droplets or water stains. However, using high-pressure air cannot reduce the chance of detecting the image by mistake due to the droplets, which may result in misjudgment of the obtained image and further result in the reduction and loss of the yield rate of the liquid crystal panel.

### SUMMARY

The present disclosure, in one aspect thereof, provides an image obtaining device and a detecting apparatus having the same. The transparent plate of the image obtaining device is driven to rotate at high speed to generate centrifugal force to throw away droplets and water stains on the transparent plate, thereby improving detecting precision.

The image obtaining device includes a waterproof casing, a CCD image transducer mounted in the waterproof casing, a motor having a driving shaft and being mounted in the waterproof casing, and a transparent plate covered on one side of the waterproof casing. The transparent plate is connected to the driving shaft of the motor and is driven to rotate by the motor.

Preferably, the transparent plate includes a supporting portion and a covering portion connected to an edge of the supporting portion, the supporting portion is covered on the waterproof casing, the covering portion is covered around the waterproof casing, and the waterproof casing cooperates with the transparent plate to define an enclosed space in which the CCD image transducer and the motor are received.

Preferably, a cleaning device capable of supplying high-pressure air is disposed inside the waterproof casing to prevent moisture outside the waterproof casing from entering into the waterproof casing.

The present disclosure, in another aspect thereof, provides a detecting apparatus. The detecting apparatus includes an image obtaining device and a LED lighting device configured corresponding to the image obtaining device. The image obtaining device includes a waterproof casing, a CCD image transducer mounted in the waterproof casing, a motor with a driving shaft mounted in the waterproof casing, and a transparent plate located outside the waterproof casing and covered on one side of the waterproof casing. The transparent plate is connected to the driving shaft of the motor and is driven to rotate by the motor.

Preferably, the LED lighting device is located above the image obtaining device and corresponds to the transparent plate.

Preferably, the transparent plate is connected on the side of the waterproof casing corresponding to the LED lighting device.

Preferably, the transparent plate includes a supporting portion and a covering portion connected to an edge of the supporting portion, the supporting portion is covered on the waterproof casing, the covering portion is covered around the waterproof casing, and the waterproof casing cooperates with the transparent plate to define an enclosed space in which the CCD image transducer and the motor are received.

Preferably, the detecting apparatus is provided with a cleaning device capable of supplying high-pressure air for preventing moisture outside the waterproof casing from entering thereinto.

Preferably, the detecting apparatus further includes an image processing device connected to the CCD image transducer.

Preferably, the LED lighting device includes a LED light and a controller for controlling on and off of the LED light.

The present disclosure, in a further aspect thereof, provides another detecting apparatus, including an image obtaining device and a LED lighting device. The image obtaining device includes a waterproof casing, a CCD image transducer mounted in the waterproof casing, a motor with a driving shaft mounted in the waterproof casing, and a transparent plate located outside the waterproof casing and covered on one side of the waterproof casing. The transparent plate is connected to the driving shaft of the motor and is driven to rotate by the motor. The LED lighting device is located above the image obtaining device and corresponding to the transparent plate.

Preferably, the transparent plate includes a supporting portion and a covering portion connected to an edge of the supporting portion, the supporting portion is covered on the waterproof casing, the covering portion is covered around the waterproof casing, and the waterproof casing cooperates with the transparent plate to define an enclosed space in which the CCD image transducer and the motor are received.

Preferably, the detecting apparatus further includes a cleaning device, the cleaning device is configured for preventing moisture outside the waterproof casing from entering into the waterproof casing by supplying high-pressure air.

Preferably, the detecting apparatus further includes an image processing device connected to the CCD image transducer.

Preferably, the LED lighting device includes a LED light and a controller for controlling on and off of the LED light.

The transparent plate of the image obtaining device and the detecting apparatus which supports the liquid crystal panel is connected to the motor and is driven by the motor to rotate at high speed to generate centrifugal force to throw away droplets and water stains on the transparent plate, which cleans the transparent plate, improving the obtaining precision of the CCD image transducer to obtain the image, and further improves the detecting precision of the liquid crystal panel and increases the yield rate of the liquid crystal panel.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 illustrates an image obtaining device in accordance with an embodiment of the present disclosure;

FIG. 2 illustrates a detecting apparatus in accordance with an embodiment of the present disclosure.

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

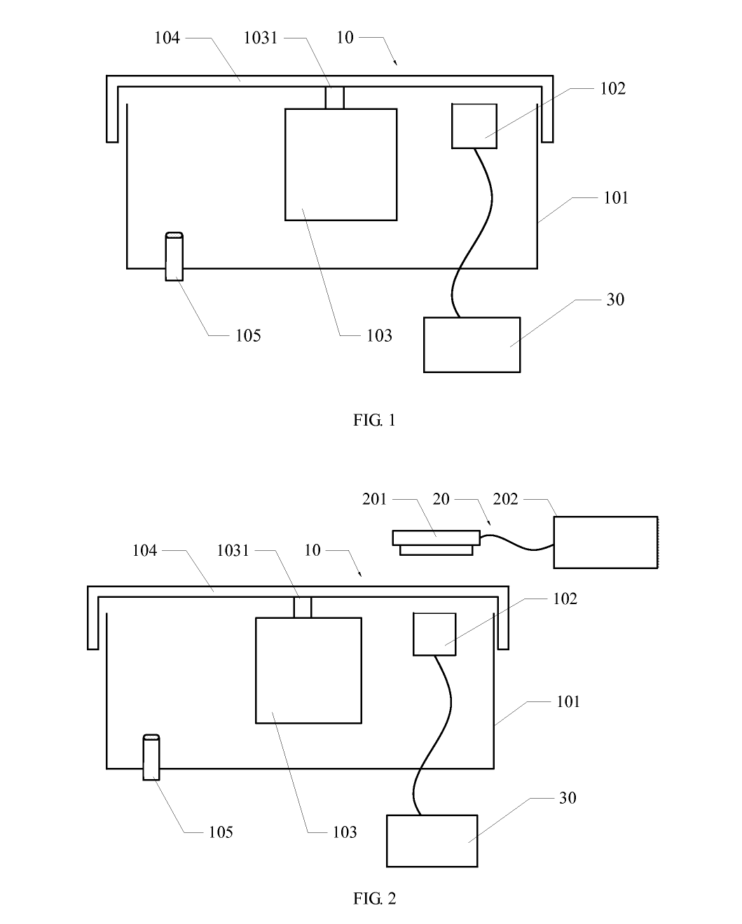

Referring to FIG. 1, which illustrates an image obtaining device 10 in accordance with an embodiment of the present disclosure, the image obtaining device 10 is used for obtaining an image of a liquid crystal panel and detecting the image to determine whether there is any defect such as image abnormality of the liquid crystal panel, for example, whether the light transmittance of the liquid crystal panel meets designing requirements. Specifically, the image obtaining device 10 includes a waterproof casing 101, a CCD image transducer 102 and a motor 103 mounted in the waterproof casing 101, and a transparent plate 104 covered on one side of the waterproof casing 101.

The waterproof casing 101 is used for defining a receiving space in which components of the image obtaining device 10 such as the CCD image transducer 102 and the motor 103 are received. The waterproof casing 101 is made of waterproof material, which is capable of preventing moisture from entering thereinto and corroding the components received therein. In the embodiment, the waterproof casing 101 is opened at the top thereof to allow the corresponding components including the CCD image transducer 102 and the motor 103 to be mounted in the waterproof casing 101 conveniently. The CCD image transducer 102 is mounted in the waterproof casing 101 for converting the light passing through the to-be-detected liquid crystal panel to electrical signals, thereby obtaining image of the liquid crystal panel. Thus, the image obtaining device 10 is capable of detecting the liquid crystal panel to determine whether there is any defect such as image abnormality of the liquid crystal panel. The transparent plate 104 cooperates with the waterproof casing 101 to define an enclosed space in which the CCD image transducer 102 and the motor 103 are received. In the embodiment, the transparent plate 104 includes a supporting portion for supporting the liquid crystal panel and a covering portion connected to the edge of the supporting portion. The supporting portion is covered on the opened side of the waterproof casing 101 and the covering portion is covered around the opened side of the waterproof casing 101. The motor 103 includes a driving shaft 1031 which is connected to the transparent plate 104, allowing the transparent plate 104 to rotate at high speed to generate centrifugal force when being driven by the motor 103.

It is understood that the transparent plate 104 is not limited to the embodiment. In other embodiments, the transparent plate 104 can be plate shaped or have other suitable shapes which allow the transparent plate 104 to support the liquid crystal panel and cooperate with the waterproof casing 101 to define an enclosed space.

Furthermore, the image obtaining device 10 includes a cleaning device 105. The outlet of the cleaning device 105 is disposed inside the waterproof casing 101 for ejecting high-pressure air towards the internal space of the waterproof casing 101, making the air pressure inside the waterproof casing 101 be higher than the atmosphere. This prevents moisture outside the waterproof casing 101 from entering thereinto and sticking to the components mounted therein, and blows the moisture out of the casing through the gap defined between the transparent plate 104 and the waterproof casing 101. In this way, even there are gaps between the transparent plate 104 and the waterproof casing 101, moisture cannot enter into the waterproof casing 101 to damage the CCD image transducer 102.

Referring to FIG. 2, which illustrates a detecting apparatus in accordance with an embodiment of the present disclosure, the detecting apparatus includes an image obtaining device 10 and a LED lighting device 20 configured corresponding to the image obtaining device 10.

The image obtaining device 10 is used for supporting the to-be-detected liquid crystal panel and converting the light passing through the liquid crystal panel to electrical signals, thereby carrying out optical detection of the liquid crystal panel. Specifically, the image obtaining device 10 includes a waterproof casing 101, a CCD image transducer 102 and a motor 103 mounted in the waterproof casing 101, and a transparent plate 104. The waterproof casing 101 is used for defining a receiving space in which components of the image obtaining device 10 such as the CCD image transducer 102 and the motor 103 are received. The waterproof casing 101 is made of waterproof material, which is capable of preventing moisture from entering thereinto to corrode the components received therein. In the embodiment, the waterproof casing 101 is opened at the top thereof to allow the corresponding components including the CCD image transducer 102 and the motor 103 to be mounted in the waterproof casing 101 conveniently. The CCD image transducer 102 is mounted in the waterproof casing 101 for converting the light passing through the to-be-detected liquid crystal panel to electrical signals, thereby obtaining image of the liquid crystal panel. Thus, the image obtaining device 10 is capable of detecting the liquid crystal panel to determine whether there is any defect such as image abnormality of the liquid crystal panel. The transparent plate 104 cooperates with the waterproof casing 101 to define an enclosed space in which the CCD image transducer 102 and the motor 103 are received. In the embodiment, the transparent plate 104 includes a supporting portion for supporting the liquid crystal panel and a covering portion connected to the edge of the supporting portion. The supporting portion is covered on the opened side of the waterproof casing 101 and the covering portion is covered around the opened side of the waterproof casing 101. The motor 103 includes a driving shaft 1031 which is connected to the transparent plate 104, allowing the transparent plate 104 to rotate at high speed to generate centrifugal force when being driven by the motor 103.

Furthermore, the image obtaining device 10 includes a cleaning device 105. An outlet of the cleaning device 105 is disposed inside the waterproof casing 101 for ejecting high-pressure air towards the internal space of the waterproof casing 101, making the air pressure inside the waterproof casing 101 be higher than the atmosphere. This prevents moisture outside the waterproof casing 101 from entering thereinto and sticking to the components mounted therein, and blows the moisture out of the casing through the gap defined between the transparent plate 104 and the waterproof casing 101. In this way, even there are gaps between the transparent plate 104 and the waterproof casing 101, moisture cannot enter into the waterproof casing 101 to damage the CCD image transducer 102.

The LED lighting device 20 includes a LED light 201 and a controller 202 connected to the LED light 201. The LED light 201 is located above the image obtaining device 10 and corresponds to the transparent plate 104. The controller 202 is connected to the LED light 201 for controlling on and off of the LED light 201, thus, the LED light can emit light towards the to-be-detected liquid crystal panel placed on the transparent plate 104.

Before using the detecting apparatus to detect the liquid crystal panel, the motor 103 of the image obtaining device 10 can be started to drive the transparent plate 104 to rotate together at high speed. At this time, under the centrifugal force of the transparent plate 104, droplets or water stains on the transparent plate 104 are driven to move away from the transparent plate 104, which cleans the transparent plate 104. Therefore, the droplets or water stains on the transparent plate 104 are prevented from affecting the image obtained by the CCD image transducer 102 in the coming detecting process. At the same time, the cleaning device 105 is started to blow high-pressure air towards the internal space of the waterproof casing 101. Thus, moisture outside the waterproof casing 101 cannot enter into the waterproof casing 101 through the gap between the transparent plate 104 and the waterproof casing 101, preventing the precision of the CCD image transducer 102 from being affected by the moisture.

After the droplets or water stains stuck to the CCD image transducer 102 is blown away from the waterproof casing 101, the liquid crystal panel can be placed on the transparent plate 104 and the LED light 201 is turned on by the controller 202. The LED light 201 emits light towards the liquid crystal panel placed on the transparent plate 104 when being turned on. The light is than transmitted towards the CCD image transducer 102 after passing through the liquid crystal panel, allowing the CCD image transducer 102 to convert the light passing through the liquid crystal panel to electrical signals and obtain corresponding images. After that, the image obtained by the CCD image transducer 102 is analyzed to determine whether the liquid crystal panel has defects related to optical images, for example, whether the light transmittance of the liquid crystal panel meets designing requirements or there is any foreign matter on the liquid crystal panel.

It is understood that, in order to reduce power consumption, the CCD image transducer 102 can be kept off while the motor 103 is driving the transparent plate 104 to rotate at high speed. The CCD image transducer 102 is turned on after the droplets or water stains on the transparent plate 104 is thrown away from the transparent plate 104 and the liquid crystal panel is placed on the transparent plate 104.

Furthermore, the detecting apparatus further includes an image processing device 30 connected to the CCD image transducer 102. After the image obtaining device 10 receives the image of the to-be-detected liquid crystal panel obtained by the CCD image transducer 102, the image obtaining device 10 transmits the image to the image processing device 30. The image processing device 30 receives the image and analyzes the image to determine whether there is any image abnormality of the liquid crystal panel or there is any foreign matter in the liquid crystal panel.

In the present disclosure, the motor 103 and the CCD image transducer 102 are mounted in the waterproof casing 101, and the transparent plate 104 is covered on the top of the waterproof casing 101 and connected to the motor 103, therefore, the motor 103 can drive the transparent plate 104 to rotate at high speed to generate centrifugal force, thereby throwing away the droplets or water stains stuck to the transparent plate 104. This cleans the transparent plate 104, improves the obtaining precision of the image by the CCD image transducer 102, and further improves the detecting precision of the detecting apparatus. At the same time, via the cleaning device 105 capable of supplying high-pressure air, moisture outside the waterproof casing 101 is prevented from entering into the waterproof casing 101 through the gap between the transparent plate 104 and the waterproof casing 101 to stick to the CCD image transducer 102 or the transparent plate 104 and to affect the detecting precision of the detecting apparatus.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. An image obtaining device, comprising:
a waterproof casing;
a CCD image transducer mounted in the waterproof casing;
a motor having a driving shaft and being mounted in the waterproof casing; and
a transparent plate covered on one side of the waterproof casing, connected to the driving shaft of the motor, and driven to rotate by the motor.

2. The image obtaining device as claimed in claim 1, wherein the transparent plate comprises a supporting portion and a covering portion connected to an edge of the supporting portion, the supporting portion is covered on the waterproof casing, the covering portion is covered around the waterproof casing, and the waterproof casing cooperates with the transparent plate to define an enclosed space in which the CCD image transducer and the motor are received.

3. The image obtaining device as claimed in claim 1, wherein a cleaning device capable of supplying high-pressure air is disposed inside the waterproof casing to prevent moisture outside the waterproof casing from entering into the waterproof casing.

4. A detecting apparatus, comprising:
an image obtaining device, comprising:
a waterproof casing;
a CCD image transducer mounted in the waterproof casing;
a motor with a driving shaft mounted in the waterproof casing; and
a transparent plate located outside the waterproof casing, covered on one side of the waterproof casing, connected to the driving shaft of the motor, and driven to rotate by the motor; and
a LED lighting device configured corresponding to the image obtaining device.

5. The detecting apparatus as claimed in claim 4, wherein the LED lighting device is located above the image obtaining device and corresponds to the transparent plate.

6. The detecting apparatus as claimed in claim 4, wherein the transparent plate is connected on the side of the waterproof casing corresponding to the LED lighting device.

7. The detecting apparatus as claimed in claim 4, wherein the transparent plate comprises a supporting portion and a covering portion connected to an edge of the supporting portion, the supporting portion is covered on the waterproof casing, the covering portion is covered around the waterproof casing, and the waterproof casing cooperates with the transparent plate to define an enclosed space in which the CCD image transducer and the motor are received.

8. The detecting apparatus as claimed in claim 7, wherein the detecting apparatus is provided with a cleaning device capable of supplying high-pressure air for preventing moisture outside the waterproof casing from entering thereinto.

9. The detecting apparatus as claimed in claim 4 further comprising an image processing device connected to the CCD image transducer.

10. The detecting apparatus as claimed in claim 9, wherein the LED lighting device comprises a LED light and a controller for controlling on and off of the LED light.

11. A detecting apparatus, comprising:
an image obtaining device, comprising:
a waterproof casing;
a CCD image transducer mounted in the waterproof casing;
a motor with a driving shaft mounted in the waterproof casing; and
a transparent plate located outside the waterproof casing, covered on one side of the waterproof casing, connected to the driving shaft of the motor, and driven to rotate by the motor; and
a LED lighting device located above the image obtaining device and corresponding to the transparent plate.

12. The detecting apparatus as claimed in claim 11, wherein the transparent plate comprises a supporting portion and a covering portion connected to an edge of the supporting portion, the supporting portion is covered on the waterproof casing, the covering portion is covered around the waterproof casing, and the waterproof casing cooperates with the transparent plate to define an enclosed space in which the CCD image transducer and the motor are received.

13. The detecting apparatus as claimed in claim 11 further comprises a cleaning device, the cleaning device is configured for preventing moisture outside the waterproof casing from entering into the waterproof casing by supplying high-pressure air.

14. The detecting apparatus as claimed in claim 11 further comprising an image processing device connected to the CCD image transducer.

15. The detecting apparatus as claimed in claim 11, wherein the LED lighting device includes a LED light and a controller for controlling on and off of the LED light.
